(19) United States
(12) Patent Application Publication
(10) Pub. No.: US 2026/0121866 A1
(43) Pub. Date: Apr. 30, 2026

(54) MAC ADDRESS-BASED ACCESS CONTROL SYSTEM FOR SECURED DATA STORAGE DEVICES

(71) Applicant: Micron Technology, Inc., Boise, ID (US)

(72) Inventors: Yogendra Singh Sikarwar, Bangalore (IN); Chaman Saurav, Bangalore (IN); Kamlendra Chandra, Bangalore (IN)

(21) Appl. No.: 19/357,431

(22) Filed: Oct. 14, 2025

Related U.S. Application Data
(60) Provisional application No. 63/714,423, filed on Oct. 31, 2024.

(51) Int. Cl. H04L 9/32; G06F 21/60; G06F 21/79; H04L 9/08

(52) U.S. Cl. CPC H04L 9/3242; G06F 21/604; G06F 21/79; H04L 9/0866

(57) ABSTRACT

In some implementations, the techniques described herein relate to a storage device including: a controller; a non-volatile memory; and a secure storage area, wherein the controller is configured to: lock the storage device to a MAC address of a host device during first boot, store the MAC address in the secure storage area, and control access to data stored in the non-volatile memory based on a comparison between the MAC address and a MAC address received from a host device.

### RELATED APPLICATIONS

The present application claims priority to U.S. Prov. Pat. App. Ser. No. 63/714,423 filed Oct. 31, 2024, the entire disclosure of which application is hereby incorporated herein by reference.

### BACKGROUND

Computer storage devices, particularly those containing sensitive or valuable data, are increasingly vulnerable to unauthorized access and data theft. Traditional security measures often rely on software-based encryption or user authentication methods, which can be circumvented by sophisticated attackers or compromised by insider threats. As computational capabilities continue to advance, even robust encryption algorithms may become susceptible to brute-force attacks given sufficient time and resources.

Current security solutions for storage devices typically implement security protocols based on, for example, Advanced Encryption Standard (AES). While AES (and similar protocols) can provide a strong level of protection, it is not impervious to all forms of attack. As computational power increases, the time required to break AES encryption through brute-force methods decreases, potentially exposing sensitive data to unauthorized access.

Moreover, existing security measures often lack granular control over data access, particularly when a storage device is connected to different host systems. This limitation can lead to increased vulnerability when a device is lost, stolen, or accessed by an unauthorized user with physical possession of the hardware.

There is a growing need for more sophisticated and adaptable security measures that can provide an additional layer of protection beyond encryption alone. Such measures may be capable of restricting access to data based on the physical characteristics of the host system, while also allowing for flexible management of access rights by the legitimate owner of the device.

The present disclosure addresses these challenges by introducing a novel approach to securing data storage devices using Media Access Control (MAC) address-based locking mechanisms. This system can enhance data protection by tying access permissions to the unique identifiers of authorized host devices, thereby creating a more robust and configurable security framework for sensitive data storage.

### BRIEF DESCRIPTION OF THE DRAWINGS

FIG. 1 is a block diagram illustrating a system for implementing a MAC address-based locking mechanism for storage devices.

FIG. 2 is a flow diagram illustrating a method for initially locking a storage drive to a specific host computer based on its MAC address.

FIG. 3 is a flow diagram illustrating a method for controlling access to a storage device that has been previously locked using a MAC address-based locking mechanism.

FIG. 4 is a block diagram illustrating a computing system according to some of the disclosed embodiments.

FIG. 5 is a block diagram of a computing device according to some of the disclosed embodiments.

### DETAILED DESCRIPTION

In some implementations, the techniques described herein relate to a storage device including: a controller; a non-volatile memory; and a secure storage area, wherein the controller is configured to: lock the storage device to a MAC address of a host device during first boot, store the MAC address in the secure storage area, and control access to data stored in the non-volatile memory based on a comparison between the MAC address and a MAC address received from a connected host device.

In some implementations, the techniques described herein relate to a storage device, wherein the controller is further configured to generate an encryption key based on the MAC address.

In some implementations, the techniques described herein relate to a storage device, wherein the controller is further configured to encrypt data stored in the non-volatile memory using the encryption key.

In some implementations, the techniques described herein relate to a storage device, wherein the secure storage area includes a write-protected region of the non-volatile memory.

In some implementations, the techniques described herein relate to a storage device, wherein the controller is further configured to monitor a rate of MAC address changes during authentication attempts.

In some implementations, the techniques described herein relate to a storage device, wherein the controller is further configured to erase data stored in the non-volatile memory if the rate of MAC address changes exceeds a predefined threshold.

In some implementations, the techniques described herein relate to a method including: detecting a first boot of a storage device; receiving a MAC address from a host device; storing the MAC address in a secure storage area of the storage device; generating an encryption key based on the MAC address; and encrypting data written to the storage device using the encryption key.

In some implementations, the techniques described herein relate to a method, further including verifying subsequent access attempts by comparing a received MAC address with the MAC address.

In some implementations, the techniques described herein relate to a method, further including denying access to the data if the received MAC address does not match the MAC address.

In some implementations, the techniques described herein relate to a method, further including monitoring a rate of MAC address changes during authentication attempts.

In some implementations, the techniques described herein relate to a method, further including erasing the data if the rate of MAC address changes exceeds a predefined threshold.

In some implementations, the techniques described herein relate to a method, further including prompting a user to disable MAC address authentication if an unapproved MAC address is detected.

In some implementations, the techniques described herein relate to a system including: a host device with a network interface card (NIC); a storage device with a secure storage area; and a key management server, wherein the storage device is configured to: receive a key from the key management server, store an approved MAC address of the NIC in the secure storage area, receive a signed command from the host device to modify MAC address-based access control, validate the signed command using the key, and update a MAC address access control register based on the signed command.

In some implementations, the techniques described herein relate to a system, wherein the storage device further includes a controller configured to generate an encryption key based on the approved MAC address.

In some implementations, the techniques described herein relate to a system, wherein the controller is further configured to encrypt data stored in a non-volatile memory of the storage device using the encryption key.

In some implementations, the techniques described herein relate to a system, wherein the secure storage area includes a write-protected region of a non-volatile memory of the storage device.

In some implementations, the techniques described herein relate to a system, wherein the storage device is further configured to monitor a rate of MAC address changes during authentication attempts.

In some implementations, the techniques described herein relate to a system, wherein the storage device is further configured to erase data stored in a non-volatile memory of the storage device if the rate of MAC address changes exceeds a predefined threshold.

In some implementations, the techniques described herein relate to a system, wherein the storage device is further configured to: compare a MAC address received from a connected host computer with the approved MAC address stored in the secure storage area, and control access to data stored in the storage device based on the comparison.

In some implementations, the techniques described herein relate to a system, wherein the storage device is further configured to deny access to the data if the received MAC address does not match the approved MAC address.

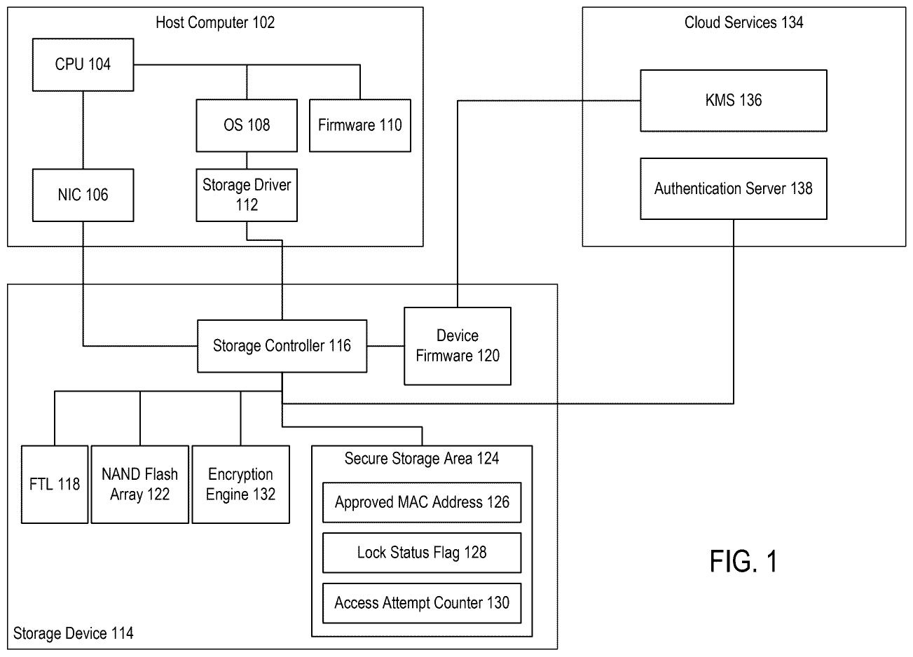

FIG. 1 is a block diagram illustrating a system for implementing a MAC address-based locking mechanism for storage devices.

The system includes a host computer 102, a storage device 114, and cloud services 134. These components work together to implement the MAC address-based locking mechanism. This ensures data on the storage device can only be accessed by authorized host systems.

The host computer 102 serves as the interface for user interaction with the storage device 114. It includes several components to implement the MAC address-based locking system. The central processing unit (CPU) 104 manages operations and coordinates the activities of other components. For example, it executes the operating system, applications, and processes necessary for implementing the MAC address-based locking mechanism. The network interface card (NIC) 106 provides the MAC address used for authentication. A MAC address is a unique identifier assigned to network interfaces for communications on the physical network segment. In this system, the MAC address of the host computer's NIC serves as the key for locking and unlocking the storage device. The operating system (OS) 108 manages the computer's hardware and software resources. In some implementations, the OS 108 facilitates communication between the host computer and the storage device. It also manages the storage driver and potentially provides APIs for retrieving the system's MAC address. Firmware 110, such as a Basic Input/Output System (BIOS) or Unified Extensible Firmware Interface (UEFI), is responsible for initializing hardware during the booting process. It's involved in detecting the storage device and potentially in the initial stages of the MAC address verification process. The storage driver 112 is a software component that enables communication between the operating system and the storage device. It translates high-level commands from the OS into low-level instructions that the storage device can understand and execute.

In some implementations, the storage device 114 implements the MAC address-based locking mechanism. The storage controller 116 is the processing unit of the storage device. It manages all operations on the device, including data read/write operations, wear leveling (for SSDs), and the implementation of the MAC address-based locking mechanism. The controller often includes dedicated hardware for encryption and other security features. In solid-state drives (SSDs), the Flash Translation Layer (FTL) 118 manages the mapping between logical block addresses used by the host system and the physical memory locations in the NAND flash. It's crucial for wear leveling and could be involved in the implementation of transparent encryption for the MAC address-based locking system. The device firmware 120 contains the logic for MAC address verification, access control, and other security features. It's responsible for implementing the locking and unlocking procedures. It also manages the secure storage of the approved MAC address and other security parameters. For SSDs, the NAND flash array 122 is the main storage medium where data is stored. In the context of the MAC address-based locking system, the NAND flash array may include reserved areas for storing security-related information. The secure storage area 124 is a protected region within the storage device where security-critical information is stored. This includes the approved MAC address 126, which is the MAC address of the authorized host system, stored securely and potentially in an encrypted form. It also includes the lock status flag 128, which indicates whether the device is currently locked or unlocked. An access attempt counter 130 tracks the number and frequency of access attempts. This is used to detect potential brute-force attacks. The AES encryption engine 132 is a hardware component dedicated to performing AES encryption and decryption operations. This allows for fast, on-the-fly encryption and decryption of data as it's written to or read from the storage device.

The cloud services component 134 provides additional security and management capabilities. The key management system (KMS) 136 is responsible for generating, distributing, and managing cryptographic keys used in the system. It may be involved in providing keys for encrypting the approved MAC address or for securing communication between the host and the storage device. The authentication server 138 provides an additional layer of authentication. This allows for remote unlocking of devices or multi-factor authentication for high-security scenarios.

The MAC address-based locking system operates through a series of processes that occur during the initial setup of the device and subsequent access attempts. During the first boot or connection of the storage device to a host system, the system initiates the locking process. The host computer detects the newly connected storage device, typically through the BIOS/UEFI during system boot or through hot-plug detection mechanisms. The storage device then checks if this is its first boot by examining a dedicated “first boot” flag stored in its secure storage area. If it is the first boot, the system proceeds to log the MAC address of the host. This process involves the host system retrieving its MAC address from the NIC, transmitting it to the storage device, and the storage device securely storing this MAC address in its secure storage area. The storage device then locks itself to this MAC address. This can include generating a unique encryption key based on the MAC address and other device-specific information.

For subsequent boots or connections, the system goes through a verification process. Upon detecting the storage device, the host system transmits its MAC address to the device. The storage device compares this received MAC address with the stored approved MAC address. If they match, the device grants access to the data. If they don't match, the device enters a monitoring mode where it tracks the rate of MAC address changes to detect potential brute-force attacks. If an unapproved MAC address is detected, the system may prompt the user to disable MAC authentication. This provides a mechanism for legitimate users to access the device from a new host system. However, if the rate of MAC address changes exceeds a predefined threshold, indicating a potential attack, the storage device can take drastic action by securely erasing all stored data.

Throughout these processes, the system implements various security measures to protect against attacks. These include safeguards against MAC address spoofing, timing attacks, and physical tampering. The system also includes provisions for secure firmware updates and rate limiting of authentication attempts. The MAC address-based locking mechanism provides a robust, hardware-level security feature that ties data access to the physical characteristics of authorized host systems. This approach offers strong protection for sensitive data. It's particularly valuable for portable storage devices or in scenarios where physical access to the storage medium cannot be guaranteed.

While providing strong security benefits, the system also includes mechanisms for legitimate users to access their data when switching to a new computer or if their network interface card is replaced. The system is designed to be compatible with standard storage interfaces and protocols. This ensures that the drive can still function with hosts that are unaware of the MAC address locking feature, albeit in a locked state.

In some implementations, systems could include the ability to authorize multiple MAC addresses for a single device by storing multiple MAC addresses using the above techniques. In some implementations, integration with remote authentication servers for enterprise environments can also be implemented. In some implementations, the system could also incorporate additional hardware-based security features. As the threat landscape evolves, such hardware-based security measures will be important in maintaining the confidentiality and integrity of stored data.

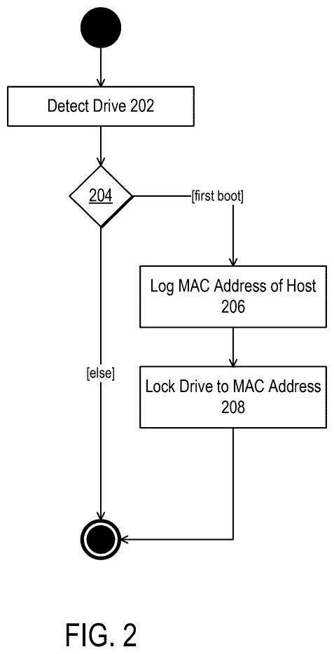

FIG. 2 is a flow diagram illustrating a method for initially locking a storage drive to a specific host computer based on its MAC address. In some implementations, this method can occur during the first boot or connection of the storage device to a host system.

At step 202, the method begins when a host computer detects that a storage drive has been connected. This detection typically occurs during the system boot method or when a drive is hot-plugged into the system. The detection mechanism may vary depending on the interface used (e.g., SATA, NVMe, USB) but generally involves the host system's BIOS or UEFI firmware recognizing the presence of a new storage device. In some embodiments, this detection step may involve power-on self-test (POST) procedures for internal drives, hot-plug detection for external or removable drives, enumeration of PCIe devices for NVMe SSDs, or USB device enumeration for external USB drives.

At step 204, after drive detection, the system determines if this is the first time the storage device has been booted or connected to a host system. This check is used for initiating the MAC address-based locking method. In some embodiments, the storage device maintains a dedicated area in its non-volatile memory to store a “first boot” flag. This flag could be a single bit in a configuration register of the storage controller, a specific value written to a reserved sector on the storage medium, or a flag stored in the device's firmware or in a secure, non-volatile memory area. For SSDs, this flag might be stored in the controller's firmware or in a small EEPROM chip on the drive's printed circuit board (PCB). For hard disk drives (HDDs), it could be written to a reserved sector on the platters or stored in the drive's firmware.

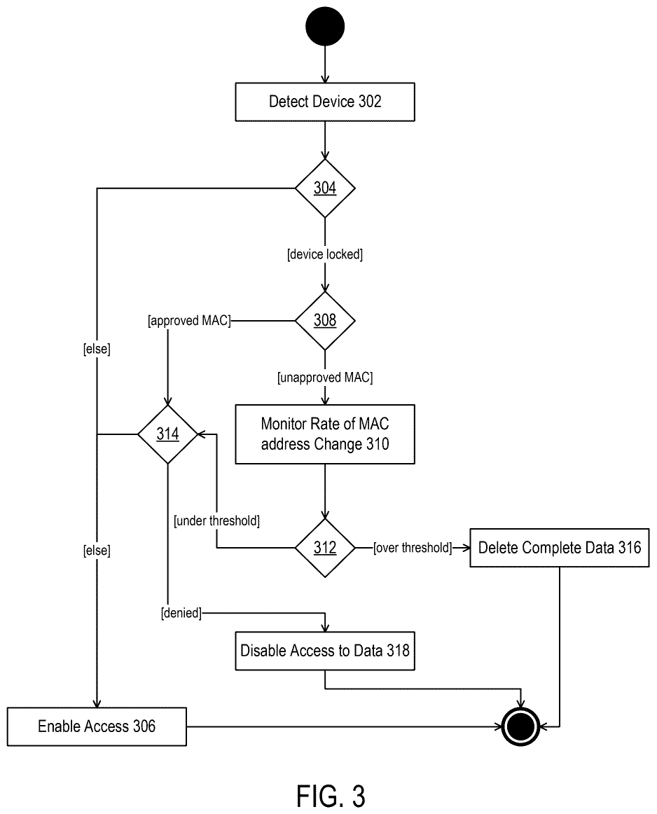

If the check at step 204 determines that this is not the first boot, the method proceeds to the normal boot sequence and lock implementation described in FIG. 3 (described next).

If the system determines at step 204 that this is indeed the first boot or connection, it proceeds to step 206, where the MAC address of the host system is logged. This step is used to establish the initial trust relationship between the storage device and the host. In some implementations, the method of logging the MAC address involves several sub-steps.

First, the host system retrieves its own MAC address, typically from its network interface card (NIC). This may involve querying the system's network configuration, accessing the NIC's firmware or EEPROM, or using operating system APIs to retrieve network interface information. Second, the host system sends the MAC address to the storage device. This transmission may occur through a custom command implemented in the storage device's firmware, an extension of existing storage protocols (e.g., SCSI, NVMe, ATA), or a secure channel established between the host and the storage device. Third, the storage device receives the MAC address and stores it in a secure, non-volatile area. This can be a dedicated section of the storage medium (e.g., a hidden partition), an encrypted area of the device's firmware, or a secure element or trusted platform module (TPM) if available on the storage device. For SSDs, the MAC address might be stored in a reserved area of the NAND flash, protected by the SSD controller's internal encryption. For HDDs, it could be written to a secure sector on the platters or stored in the drive's firmware.

At step 208, once the MAC address is logged, the method can include locking the drive to this specific MAC address.

In some implementations, the storage device can generate a unique encryption key based on the stored MAC address. This key generation method may involve using the MAC address as a seed for a cryptographically secure pseudo-random number generator (CSPRNG), applying a key derivation function (KDF) to the MAC address, or combining the MAC address with other device-specific information to create a unique key.

In some implementations, the storage device can use this generated key to encrypt its contents. For SSDs, this might involve utilizing the SSD controller's built-in AES encryption engine, applying full-disk encryption to all user-accessible areas of the NAND flash, or implementing transparent encryption at the flash translation layer (FTL) level. For HDDs, encryption could be implemented using the drive's onboard processor and encryption hardware, applied at the sector level during write operations.

In some implementations, the storage device can implement an access control system that requires MAC address verification before allowing data access. This involves storing the access control logic in the device's firmware, implementing secure boot procedures to ensure the integrity of this access control mechanism, and creating a challenge-response protocol for MAC address verification.

In some implementations, the device can securely store information about its locked state, including the fact that it is now locked (updating the “first boot” flag), a secure hash or representation of the authorized MAC address, and any additional metadata needed for the locking mechanism (e.g., timestamp, lock version). This information is stored in a tamper-resistant manner, potentially using write-once memory areas in the storage controller, encrypted storage in a reserved area of the storage medium, or secure elements or hardware security modules if available.

In some implementations, the locking system can include provisions for legitimate access scenarios where the original host system may not be available. This could involve a secure unlock procedure using a pre-defined master password or key, a multi-factor authentication system for unlocking from new hosts, or integration with a trusted remote server for unlocking authorization.

In some embodiments, the locking mechanism is designed to have minimal impact on the storage device's performance. For SSDs, this might involve utilizing the controller's dedicated encryption engines, implementing the access check in parallel with other initialization procedures, and optimizing the MAC address verification process to minimize latency.

The locking system can be designed to be compatible with standard storage interfaces and protocols, ensuring that the drive can still function with hosts that are unaware of the MAC address locking feature, albeit in a locked state. In some embodiments, the system may be designed to potentially accommodate multiple authorized MAC addresses, allowing for legitimate use across several host systems if desired.

Additional security measures may be implemented to protect against potential attacks, such as MAC address spoofing protection, safeguards against brute-force attempts to guess the authorized MAC address, and protections against physical tampering or side-channel attacks on the storage device.

After the completion of step 208, the method moves to the normal boot sequence and ongoing enforcement of the MAC address lock, which is described next in connection with FIG. 3.

FIG. 3 is a flow diagram illustrating a method for controlling access to a storage device that has been previously locked using a MAC address-based locking mechanism. In some implementations, this method occurs during subsequent boots or connections of the storage device to a host system after the initial locking procedure described in FIG. 2 has been completed.

The method begins at step 302, where the host system detects the presence of a storage device. This detection typically occurs during the system boot process or when a drive is hot-plugged into the system. The specific mechanism for device detection may vary depending on the interface used, such as Serial ATA (SATA), Non-Volatile Memory Express (NVMe), or Universal Serial Bus (USB). In general, the host system's BIOS or UEFI firmware recognizes the presence of the storage device and initiates the appropriate initialization procedures.

For internal drives, this detection may involve POST procedures. In the case of external or removable drives, hot-plug detection mechanisms may be employed. NVMe SSDs may be detected through PCIe device enumeration, while external USB drives would typically be identified through the USB device enumeration process. The storage device controller, which may be implemented as an Application-Specific Integrated Circuit (ASIC) or a System-on-Chip (SoC), can respond to initialization commands from the host system and provide device identification and capacity information.

Once the device is detected, the process moves to step 304, where the method checks if the detected device is locked. This check is used to determine whether the MAC address-based security measures need to be enforced. The method for performing this check may vary depending on the specific implementation of the locking mechanism. In one embodiment, the storage device may maintain a dedicated flag in a secure, non-volatile area of its memory to indicate its locked status. This flag could be a single bit in a configuration register of the storage controller, a specific value written to a reserved sector on the storage medium, or a flag stored in the device's firmware.

For SSDs, this locked status flag might be stored in the controller's firmware or in a small Electrically Erasable Programmable Read-Only Memory (EEPROM) chip on the drive's PCB. In the case of HDDs, it could be written to a secure sector on the platters or stored in the drive's firmware. The host system may need to issue a specific command or query to the storage device to retrieve this locked status information. This interaction between the host and the storage device can be secure, preventing unauthorized parties from easily bypassing or spoofing the locked status check.

If the device is determined to be unlocked at step 304, the method proceeds to step 306, where normal access to the device's data is enabled. In this case, the storage device operates as a standard, unprotected drive, allowing read and write operations without any additional MAC address-based security checks. The method then terminates, having granted full access to the unlocked device.

However, if the device is determined to be locked at step 304, the method continues to step 308, where the method checks if an approved MAC address is detected. This step involves comparing the MAC address of the current host system with the MAC address that was used to initially lock the device, as described in FIG. The storage device can securely store the approved MAC address, typically in an encrypted or hashed form to prevent unauthorized access or tampering.

The process of MAC address verification may involve several sub-steps. First, the host system can retrieve its own MAC address, typically from its NIC. This may involve querying the system's network configuration, accessing the NIC's firmware or EEPROM, or using operating system APIs to retrieve network interface information. Next, the host system can transmit this MAC address to the storage device for verification. This transmission can occur through a secure channel or using a cryptographic protocol to prevent interception or manipulation of the MAC address during transmission.

Upon receiving the host's MAC address, the storage device compares it with the stored approved MAC address. This comparison can be performed in a secure manner, potentially using constant-time comparison algorithms to prevent timing-based side-channel attacks. If the MAC addresses match, the method moves to step 3 If they do not match, the method continues to step 310.

At step 310, the method begins monitoring the rate of MAC address changes. This monitoring process is a security feature designed to detect and prevent potential brute-force attacks or unauthorized access attempts. The storage device keeps track of how frequently different MAC addresses are presented for authentication. This monitoring may involve maintaining a secure log of authentication attempts, including timestamps and the number of unique MAC addresses presented within a given time frame.

The monitoring continues at step 312, where the method checks if the rate of MAC address changes exceeds a predefined threshold. This threshold is a security parameter that balances between allowing legitimate access attempts and preventing malicious activities. The specific threshold value may depend on various factors, including the security requirements of the use case, the expected frequency of legitimate host changes, and the computational capabilities of potential attackers.

If the rate of MAC address changes does not exceed the threshold at step 312, the method moves to step 3 If the threshold is exceeded, indicating a potential attack, the method proceeds to step 316, where the storage device takes drastic action by deleting all stored data. This data deletion can be performed securely, potentially using multiple overwrite passes to ensure that the data cannot be recovered through forensic analysis techniques. After the data deletion is complete, the method terminates, leaving the storage device in a secure but empty state.

At step 314, the system prompts the user to disable MAC address authentication. This step provides a mechanism for legitimate users to access the device from a new host system with a different MAC address. The prompt can be designed to clearly inform the user of the security implications of disabling the MAC address authentication. It may include warnings about the potential risks and may require additional authentication factors to proceed with disabling the security feature.

If the user chooses not to disable MAC authentication at step 314, the process moves to step 318, where access to the device's data is disabled. This ensures that the data remains protected even when an unauthorized MAC address is detected. The disabling of access can be implemented at a low level within the storage device's firmware or controller, preventing any read or write operations to the protected data areas. After disabling access, the process terminates, leaving the device in a locked state.

If the user chooses to disable MAC authentication at step 314, the method proceeds to step 306, where access to the device's data is enabled. This step involves unlocking the encryption mechanism that protects the data on the storage device. The specific method for enabling access may vary depending on the implementation of the locking mechanism.

For SSDs, enabling access might involve providing the correct encryption key to the SSD controller's built-in AES encryption engine. This could allow the controller to decrypt data as it is read from the NAND flash and encrypt data as it is written. The encryption key used for this process would be the one generated during the initial locking procedure, which was derived from or associated with the approved MAC address.

In the case of HDDs, enabling access could involve unlocking the drive's onboard encryption hardware and providing it with the necessary key to decrypt data at the sector level during read operations and encrypt data during write operations. The encryption key would similarly be derived from or associated with the approved MAC address.

It's important to note that even when access is enabled, the storage device should maintain its locked status and continue to perform MAC address checks on subsequent connections. This ensures that the security measure remains in effect for future use, protecting against scenarios where an attacker might gain temporary access to an unlocked device.

Throughout this entire process, the storage device can implement robust security measures to protect against various potential attacks. In one implementation, the method can implement mechanisms to detect and prevent the use of spoofed MAC addresses. This can involve additional verification steps or the use of cryptographic protocols that tie the MAC address to other unique identifiers of the host system.

In another implementation, the time taken to perform MAC address comparisons and other security checks should be constant, regardless of whether the check succeeds or fails. This prevents attackers from inferring information based on the time taken to process different inputs.

In some implementations, all security-related information stored on the device, such as the approved MAC address and the locked status flag, can be encrypted to prevent unauthorized access or tampering.

In some implementations, the method can provide a mechanism for securely updating the device's firmware to address any discovered vulnerabilities or to enhance the security features over time. These updates can be cryptographically signed to ensure their authenticity.

In some implementations, the storage device can implement measures to detect and respond to physical tampering attempts. This could include the use of tamper-evident seals, encrypted storage for critical security parameters, and mechanisms to erase sensitive data if physical tampering is detected.

In addition to monitoring the rate of MAC address changes, the system can implement rate limiting on authentication attempts to further protect against brute-force attacks.

The MAC address-based locking method provides a robust, hardware-level security feature for storage devices. By tying data access to the physical characteristics of authorized host systems, it offers an additional layer of protection beyond traditional software-based security measures. This method is particularly valuable for protecting sensitive data on portable storage devices or in scenarios where physical access to the storage medium cannot be guaranteed.

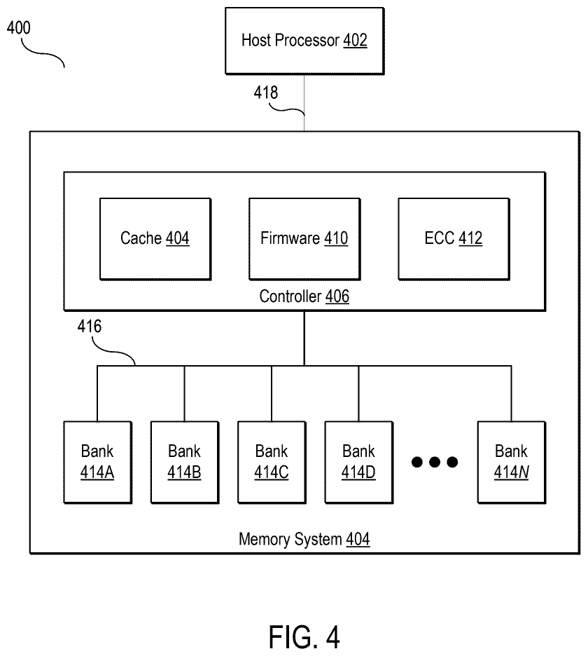

FIG. 4 is a block diagram illustrating a computing system according to some of the disclosed embodiments.

As illustrated in FIG. 4, a computing system 400 includes a host processor 402 communicatively coupled to a memory system 404 via a bus 4 The memory system 404 comprises a controller 406 communicatively coupled to one or more memory banks (e.g., bank 414A, bank 414B, bank 414C, bank 414D, bank 414N, etc.) forming a memory array via an interface 4 As illustrated, the controller 406 include a local cache 408, firmware 410, and an ECC 412.

In the illustrated embodiment, host processor 402 can comprise any type of computer processor, such as a central processing unit (CPU), graphics processing unit (GPU), or other types of general-purpose or special-purpose computing devices. The host processor 402 includes one or more output ports that allow for the transmission of address, user, and control data between the host processor 402 and the memory system 4 In the illustrated embodiment, this communication is performed over the bus 4 In one embodiment, the bus 416 comprises an input/output (I/O) bus or a similar type of bus.

The memory system 404 is responsible for managing one or more memory banks. In one embodiment, the memory banks comprise NAND Flash dies or other configurations of non-volatile memory. In one embodiment, the memory banks comprise a memory array.

The memory banks are managed by the controller 4 In some embodiments, the controller 406 comprises a computing device configured to mediate access to and from banks. In one embodiment, the controller 406 comprises an ASIC or other circuitry installed on a printed circuit board housing the memory banks. In some embodiments, the controller 406 may be physically separate from the memory banks. The controller 406 communicates with the memory banks over the interface 4 In some embodiments, this interface 418 comprises a physically wired (e.g., traced) interface. In other embodiments, the interface 418 comprises a standard bus for communicating with memory banks.

The controller 406 comprises various modules including local cache 408, firmware 410 and ECC 4 In one embodiment, the various modules (e.g., local cache 408, firmware 410 and ECC 412) comprise various physically distinct modules or circuits. In other embodiments, the modules (e.g., local cache 408, firmware 410 and ECC 412) may completely (or partially) be implemented in software or firmware.

As illustrated, firmware 410 comprises the core of the controller and manages all operations of the controller 4 The firmware 410 may implement some or all of the methods described above. Specifically, the firmware 410 may implement the methods described in the foregoing figures.

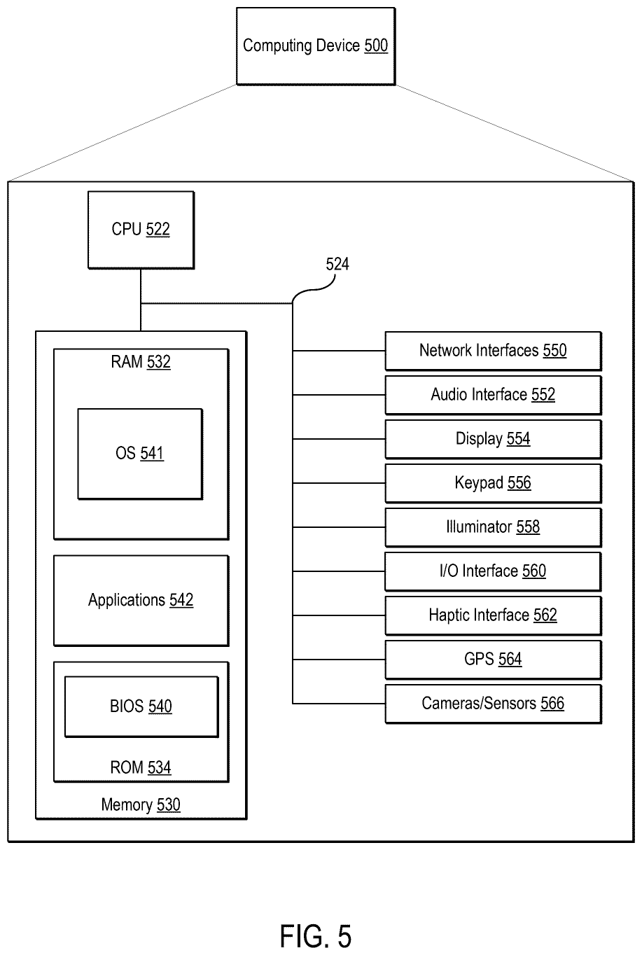

FIG. 5 is a block diagram of a computing device according to some of the disclosed embodiments.

As illustrated, the device 500 includes a processor or central processing unit (CPU) such as CPU 502 in communication with a memory 504 via a bus 4 The device also includes one or more input/output (I/O) or peripheral devices 5 Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 502 may comprise a general-purpose CPU. The CPU 502 may comprise a single-core or multiple-core CPU. The CPU 502 may comprise a SoC or a similar embedded system. In some embodiments, a graphics processing unit (GPU) may be used in place of, or in combination with, a CPU 5 Memory 504 may comprise a memory system including a dynamic random-access memory (DRAM), static random-access memory (SRAM), Flash (e.g., NAND Flash), or combinations thereof. In one embodiment, the bus 414 may comprise a Peripheral Component Interconnect Express (PCIe) bus. In some embodiments, the bus 414 may comprise multiple busses instead of a single bus.

Memory 504 illustrates an example of a non-transitory computer storage media for the storage of information such as computer-readable instructions, data structures, program modules, or other data. Memory 504 can store a BIOS in read-only memory (ROM), such as ROM 508 for controlling the low-level operation of the device. The memory can also store an operating system in random-access memory (RAM) for controlling the operation of the device.

Applications 510 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 507 by CPU 5 CPU 502 may then read the software or data from RAM 507, process them, and store them in RAM 507 again.

The device may optionally communicate with a base station (not shown) or directly with another computing device. One or more network interfaces in peripheral devices 512 are sometimes referred to as a transceiver, transceiving device, or network interface card (NIC).

An audio interface in peripheral devices 512 produces and receives audio signals such as the sound of a human voice. For example, an audio interface may be coupled to a speaker and microphone (not shown) to enable telecommunication with others or generate an audio acknowledgment for some action. Displays in peripheral devices 512 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 512 may comprise any input device arranged to receive input from a user. An illuminator in peripheral devices 512 may provide a status indication or provide light. The device can also comprise an input/output interface in peripheral devices 512 for communication with external devices, using communication technologies, such as USB, infrared, Bluetooth®, or the like. A haptic interface in peripheral devices 512 provides tactile feedback to a user of the client device.

A GPS receiver in peripheral devices 512 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a MAC address, Internet Protocol (IP) address, or the like.

The device may include more or fewer components than those shown in FIG. 5, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

These computer program instructions can be provided to a processor of a general-purpose computer to alter its function to a special purpose; a special purpose computer; ASIC; or other programmable digital data processing apparatus, such that the instructions, which execute via the processor of the computer or other programmable data processing apparatus, implement the functions or acts specified in the block diagrams or operational block or blocks, thereby transforming their functionality in accordance with embodiments herein.

For the purposes of this disclosure a computer readable medium (or computer-readable storage medium) stores computer data, which can include computer program code or instructions that are executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable, and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid-state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all the features described herein are possible.

Functionality may also be, in whole or in part, distributed among multiple components, in manners now known or to become known. Thus, a myriad of software, hardware, and firmware combinations are possible in achieving the functions, features, interfaces, and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

1. A storage device comprising:
a controller;
a non-volatile memory; and
a secure storage area,
wherein the controller is configured to:
lock the storage device to a MAC address of a host device during first boot,
store the MAC address in the secure storage area, and
control access to data stored in the non-volatile memory based on a comparison between the MAC address and a MAC address received from the host device.

2. The storage device of claim 1, wherein the controller is further configured to generate an encryption key based on the MAC address.

3. The storage device of claim 2, wherein the controller is further configured to encrypt data stored in the non-volatile memory using the encryption key.

4. The storage device of claim 1, wherein the secure storage area comprises a write-protected region of the non-volatile memory.

5. The storage device of claim 1, wherein the controller is further configured to monitor a rate of MAC address changes during authentication attempts.

6. The storage device of claim 5, wherein the controller is further configured to erase data stored in the non-volatile memory if the rate of MAC address changes exceeds a predefined threshold.

7. A method comprising:
detecting a first boot of a storage device;
receiving a MAC address from a host device;
storing the MAC address in a secure storage area of the storage device;
generating an encryption key based on the MAC address; and
encrypting data written to the storage device using the encryption key.

8. The method of claim 7, further comprising verifying subsequent access attempts by comparing a received MAC address with the MAC address.

9. The method of claim 8, further comprising denying access to the data if the received MAC address does not match the MAC address.

10. The method of claim 7, further comprising monitoring a rate of MAC address changes during authentication attempts.

11. The method of claim 10, further comprising erasing the data if the rate of MAC address changes exceeds a predefined threshold.

12. The method of claim 7, further comprising prompting a user to disable MAC address authentication if an unapproved MAC address is detected.

13. A system comprising:
a host device with a network interface card (NIC);
a storage device with a secure storage area; and
a key management server, wherein the storage device is configured to:
receive a key from the key management server,
store an approved MAC address of the NIC in the secure storage area,
receive a signed command from the host device to modify MAC address-based access control,
validate the signed command using the key, and
update a MAC address access control register based on the signed command.

14. The system of claim 13, wherein the storage device further comprises a controller configured to generate an encryption key based on the approved MAC address.

15. The system of claim 14, wherein the controller is further configured to encrypt data stored in a non-volatile memory of the storage device using the encryption key.

16. The system of claim 13, wherein the secure storage area comprises a write-protected region of a non-volatile memory of the storage device.

17. The system of claim 13, wherein the storage device is further configured to monitor a rate of MAC address changes during authentication attempts.

18. The system of claim 17, wherein the storage device is further configured to erase data stored in a non-volatile memory of the storage device if the rate of MAC address changes exceeds a predefined threshold.

19. The system of claim 13, wherein the storage device is further configured to: compare a MAC address received from a connected host computer with the approved MAC address stored in the secure storage area, and control access to data stored in the storage device based on the comparison.

20. The system of claim 19, wherein the storage device is further configured to deny access to the data if the received MAC address does not match the approved MAC address.
